(19) United States
(12) Patent Application Publication
(10) Pub. No.: US 2014/0090672 A1
(43) Pub. Date: Apr. 3, 2014

(54) PALLET DRYING METHOD, PALLET DRYING DEVICE, AND PALLET CLEANING DEVICE

(71) Applicant: Takanobu Matsui, Chiyodsa-ku (JP)

(72) Inventor: Takanobu Matsui, Chiyodsa-ku (JP)

(73) Assignee: JAPAN PALLET RENTAL CORPORATION, Chhiyoda-ku, Tokyo (JP)

(21) Appl. No.: 14/119,741

(22) PCT Filed: May 25, 2011
(86) PCT No.: PCT/JP2011/062029

§ 371 Date: Dec. 17, 2013

(51) Int. Cl. F26B 9/10; B08B 3/04

(52) U.S. Cl. CPC F26B 9/106; B08B 3/04
USPC 134/61; 34/443; 34/237

(57) ABSTRACT

A pallet drying device promotes drying after washing of a pallet including a fork insertion hole into which a fork is inserted on a side surface and an opening communicating with the fork insertion hole on a lower surface. The pallet drying device includes: pallet placing means capable of placing the pallet to be dried so as to mechanically block the opening; and blowing means for blowing air into the inside of the fork insertion hole. The pallet is placed with the opening on the lower surface blocked while air is blown into the fork insertion hole, thus the air blown into the fork insertion hole is not discharged from the opening. This configuration promotes drying the inside of the fork insertion hole.

### TECHNICAL FIELD

The present invention relates to a pallet drying method, a pallet drying device, and a pallet washing device.

### BACKGROUND ART

Pallets formed of resin such as plastic are used for. transporting goods in a variety of industries. As pallets are repeatedly used, pallets that are used a certain number of times require washing. Resin pallets are washed, for example, with water or liquid cleaner. To reuse the washed pallets, the pallets need to be dried. In a conventional pallet washing step, for example, water remaining on a pallet is removed with a blower to promote drying the pallet. A method of promoting drying of a pallet by blowing hot air onto the pallet with a blower and a method of promoting drying after washing by heating wash water are also known. A pallet washing system is also known, which dries a pallet by hot air after the pallet is centrifugally spun for dewatering (see, for example, Patent Literature 1).

### CITATION LIST

### Patent Literature

Patent Literature 1: Japanese Patent Application Laid-Open Publication No. 2010-125388

### SUMMARY OF INVENTION

### Technical Problem

Usually, such a pallet includes a fork insertion hole. The inside of fork insertion hole needs to be surely dried after washing. In a conventional method, warm air from a blower is blown against the entire pallet, thus the inside of the fork insertion hole cannot be sufficiently dried. In addition, since the warm air is blown against the entire pallet, the blower blowing warm air and a heat source heating air need to be large devices. Consequently, operation of the devices needs a lot of energy and cost. Furthermore, the warm air blown into the inside of the fork insertion hole is discharged from an opening communicating with the fork insertion hole, which makes it difficult to dry the fork insertion hole.

A method for dewatering a pallet by centrifugal spin consumes a lot of energy in a power source for spinning the pallet, which needs high cost. Furthermore, the spin of such a heavy pallet is rapidly accelerated and decelerated, which greatly damages a device spinning the pallet and needs high maintenance cost. In addition, the method fails to sufficiently dry the inside of the fork insertion hole.

With the method of washing a pallet with heated wash water, initial cost and running cost for a heater for heating wash water, and a circulator, a filter, and other devices for recycling wash water are high.

The present invention is made in view of the problems described above. An object of the present invention is to provide a pallet drying method, a pallet drying device, and a pallet washing device that are capable of drying reliably, with low energy at low cost, the inside of a fork insertion hole of a washed pallet.

### Solution to Problem

A pallet drying method according to an embodiment of the present invention that promotes drying after washing of a pallet including a fork insertion hole into which a fork is inserted on a side surface and an opening communicating with the fork insertion hole on a lower surface, the pallet drying method including: a pallet placing step of placing the pallet to be dried on a certain position so as to mechanically block the opening; and a blowing step of blowing air into the inside of the fork insertion hole.

A pallet drying device according to an embodiment of the present invention that promotes drying after washing of a pallet including a fork insertion hole into which a fork is inserted on a side surface and an opening communicating with the fork insertion hole on a lower surface, the pallet drying device including: pallet placing means capable of placing the pallet to be dried so as to mechanically block the opening; and blowing means for blowing air into the inside of the fork insertion hole.

In the pallet drying method and the pallet drying device according to an embodiment of the present invention, the pallet to be dried is placed with the opening on the lower surface blocked while air is blown into the fork insertion hole. Thus the air blown into the fork insertion hole is not discharged from the opening. This configuration promotes drying the inside of the fork insertion hole. The air blown to the pallet is generated to the fork insertion hole but not to the entire pallet, and therefore, a device blowing air can be miniaturized.

Consequently, the energy and cost needed to dry the pallet can be reduced.

In the pallet drying device according to an embodiment of the present invention, it is preferable that the pallet placing means be provided with a stacker that is a device for stacking pallets, and the opening of the pallet to be dried be blocked with the upper surface of one of the pallets stacked under the pallet to be dried.

In the pallet drying method according to an embodiment of the present invention, it is preferable that in the pallet placing step, a stacker that is a device for stacking a plurality of pallets stack the pallets, and the opening of the pallet to be dried be blocked with the upper surface of one of the pallets stacked under the pallet to be dried.

With the method and the device, the opening of the pallet to be dried is blocked with the upper surface of the pallet, among the stacked pallets on the stacker, stacked under the pallet to be dried. Thus, the opening on the lower surface of the pallet is reliably blocked without using a special component other than the devices generally used to handle the pallets.

In the pallet drying device according to an embodiment of the present invention, it is preferable that the pallet placing means include a lifter provided with a table including a placement surface on which the pallet is placed, and a power source capable of lifting the table, and the placement surface of the table may block the opening of the pallet to be dried.

In the pallet drying method according to an embodiment of the present invention, it is preferable that, in the pallet placing step, a lifter provided with a table including a placement surface on which the pallets are placed and a power source capable of lifting the table may be used to place the pallet to be dried on the table, and the opening of the pallet to be dried may be blocked with the placement surface of the table.

With the method and the device, the opening of the pallet to be dried is blocked with the upper surface of the table of the lifter. Thus, the opening on the lower surface of the pallet is reliably blocked without using a special component other than the devices generally used to handle the pallets.

In the pallet drying method according to an embodiment of the present invention, it is preferable that, in the blowing step, air heated with a heat source be blown into the inside of the fork insertion hole. In this case, the fork insertion hole is dried efficiently because hot blast which is the air heated with the heat source is blown into the inside of the fork insertion hole.

In the pallet drying device according to an embodiment of the present invention, the blowing means may include a heat source that heats air, a blower that blows hot blast which is the air heated with the heat source, and a duct that forms a flow path for the hot blast blown from the blower and includes a hot-blast discharging port directed to the inside of the fork insertion hole.

With this configuration, the hot blast which is the air heated with the heat source is blown and guided to the fork insertion hole through the duct. Thus, the hot blast directed to the fork insertion hole can be generated reliably.

A pallet washing device according to an embodiment of the present invention is provided for washing a pallet. The pallet washing device includes a washing unit that washes the pallet with water, the pallet drying device as described above provided at a stage subsequent to the washing unit, and a conveyance unit that conveys the pallet washed in the washing unit to the pallet placing means in the pallet drying device.

The pallet drying device is provided at a stage subsequent to the washing unit, whereby the washed pallet can be dried reliably with the pallet drying device. A preferred pallet washing device is thus configured.

### Advantageous Effects of Invention

The present invention enables reliable drying of the inside of a fork insertion hole of a washed pallet with low energy at low cost.

### BRIEF DESCRIPTION OF DRAWINGS

FIG. 1 is a schematic side view of a pallet drying device.

FIG. 2 is a perspective view of a pallet.

FIG. 3(a) is a side view of the pallet seen from a direction of the arrow A in FIG. 2. FIG. 3(b) is a side view of the pallet seen from a direction of the arrow B in FIG. 2. FIG. 3(c) is a bottom view of the pallet seen from a direction of the arrow C in FIG. 2.

FIG. 4 is a schematic side view of blowing means.

FIG. 5 is an enlarged diagram illustrating the duct shown in FIG. 4.

FIG. 6 is a side view illustrating pallets placed on a stacker.

FIG. 7(a) is a side view of pallets placed on a lifter seen along a perforating direction of fork insertion holes. FIG. 7(b) is a side view of the pallets placed on the lifter seen along a direction perpendicular to the perforating direction of the fork insertion holes.

FIG. 8 is a perspective view of a pallet washing device.

### DESCRIPTION OF EMBODIMENTS

A pallet drying device according to an embodiment of the present invention will be described in detail below with reference to the accompanying drawings. It is noted that in all of the drawings, the same or corresponding parts are denoted with the same reference signs.

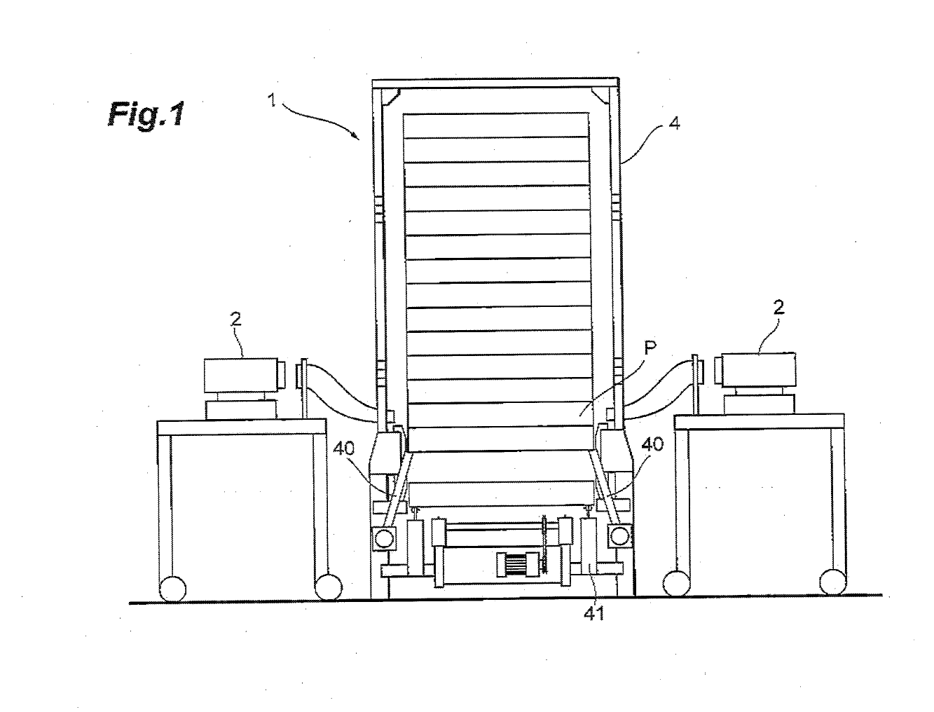

A pallet drying device 1 in the present embodiment is shown in FIG. 1. FIG. 1 is a schematic side view of the pallet drying device 1. The pallet drying device 1 is a device that promotes drying a washed pallet. A pallet to be dried in the present embodiment includes a fork insertion hole into which a fork is inserted on a side surface, and an opening communicating with the fork insertion hole on a lower surface. The pallet drying device 1 includes blowing means 2 and a stacker 4 as shown in FIG. 1.

The following describes the stacker 4 before explaining the blowing means 2. The stacker 4 is a device for stacking a pallet P and can configure pallet stacking means for placing a pallet to be dried.

As shown in FIG. 1, the stacker 4 includes a pallet stacking unit 40 and a pallet receiving unit 41. The pallet stacking unit 40 has a mechanism that supports stacked pallets. The pallet stacking unit 40 supports the stacked pallet by putting the pallet P raised by the pallet receiving unit 41 under pallets P already supported, thereby further stacking the pallet P. The pallet receiving unit 41 is a unit that receives the washed pallet P and on which the received pallet is placed. The pallet receiving unit 41 has a mechanism that raises the placed pallet P to a supporting position of the pallet stacking unit 40 while supporting the pallet P. The stacker 4 in the present embodiment can be configured with a stacker well known to the skilled person and is not limited to the embodiment illustrated in the drawings.

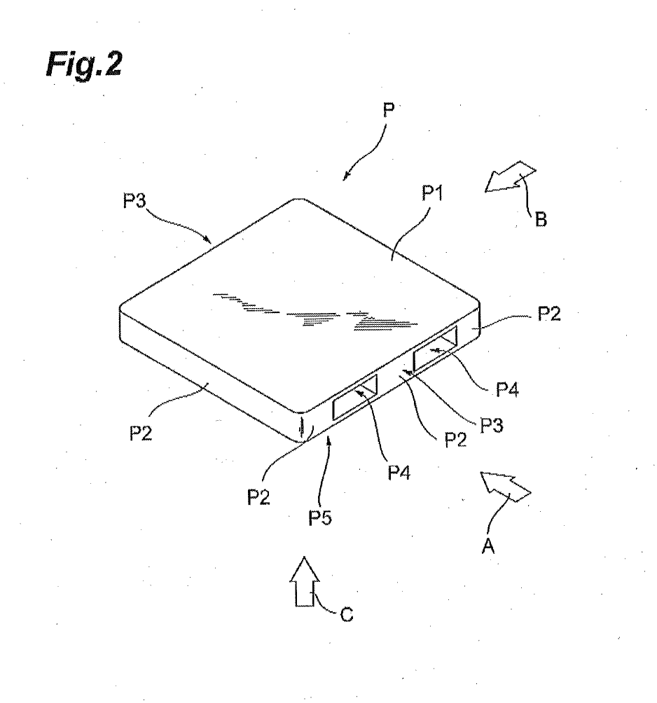

Referring now to FIG. 2, an example of the pallet P to be washed and dried in the present embodiment will be described. FIG. 2 is a perspective view of the pallet P. As shown in FIG. 2, the pallet P has an upper deck P1 that forms an approximately square main surface on which a cargo is put, a lower deck P5 that forms an approximately square lower surface opposed to the main surface, and a beam P2 that connects the upper deck P1 to the lower deck P5. The pallet P is also provided with at least a pair of fork insertion holes P4 passing through opposing side surfaces P3 structured with the beam P2.

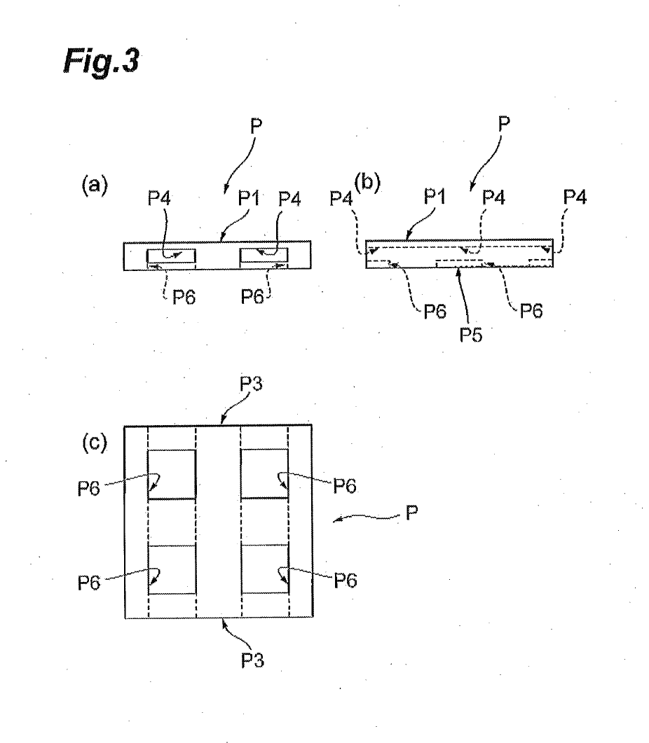

Next, the pallet P is further explained with reference to FIG. 3. FIG. 3(a) is a side view of the pallet seen from a direction of the arrow A in FIG. 2. FIG. 3(b) is a side view of the pallet seen from a direction of the arrow B in FIG. 2. FIG. 3(c) is a bottom view of the pallet seen from a direction of the arrow C in FIG. 2. As shown in FIGS. 3(a) to 3(c), the pallet P is provided with four openings P6 on the lower surface. The openings P6 are almost squares and communicating with the fork insertion holes P4. In an example shown in FIG. 3, the two openings P6 are provided so as to communicate with the single fork insertion hole P4.

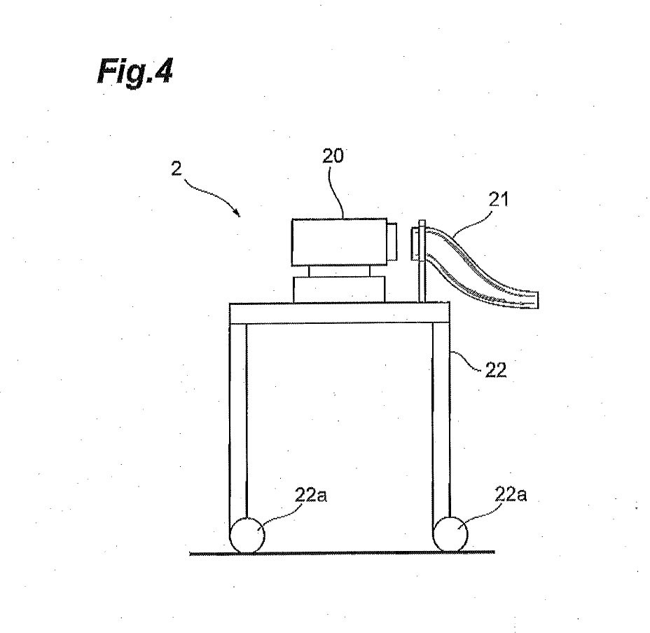

Next, the blowing means 2 will be described in detail with reference to FIG. 4. As shown in FIG. 4, the blowing means 2 includes a hot blast generator 20 and a duct 21. The hot blast generator 20 includes a heater and a blower. The heater is a component of a heat source heating air. The blower blows hot blast which is the air heated by the heater. Although the blowing means 2 blows the hot blast into the insides of the fork insertion holes P4 in the present embodiment, another embodiment in which air at room temperature instead of the hot blast is blown may be applicable. In other words, the blowing means 2 may not include the heat source.

As the hot blast generator 20, BR-121J (trade name) manufactured by Sunpot Co., Ltd., can be used, for example. This device has a thermal output of 8.72 kW to 14 kW and generates a hot blast of 3.7 m³/minute to 5.4 m³/minute. In the conventional method for blowing hot blast onto the entire pallet, for example, the air heated with a boiler having a thermal output of several hundred kilowatts is blown onto the entire pallet. In contrast to the conventional method, in the present embodiment, hot blast is blown into the fork insertion holes P4 from both ends thereof, thus, the pallet drying device 1 includes four such hot blast generators 20. The thermal output of each hot blast generator 20 included in the pallet drying device 1 in the present embodiment is less than 60 kW. Consequently, the thermal output needed for the pallet drying method using the pallet drying device 1 in the present embodiment is smaller than that for the conventional method. With this configuration, the present embodiment can make the blowing means 2 smaller than that for the conventional method. Furthermore, pallets can be dried with low energy at low cost. The hot blast generator 20 may have a different configuration that includes a boiler having nearly the same thermal output as that of the heater in the present embodiment and a blower.

The duct 21 has a tubular shape and forms a flow path of the hot blast blown from the hot blast generator 20. The duct 21 may be provided with a heat insulating material to cover an outer surface thereof. Providing the heat insulating material can prevent decrease in the temperature of the hot blast from the hot blast generator 20.

The hot blast generator 20 may be placed on a wagon 22 as shown in FIG. 4. The wagon 22 includes casters 22a on its legs. The casters 22a allow the blowing means 2 to move freely, thus the maintenance of the pallet drying device 1 is facilitated.

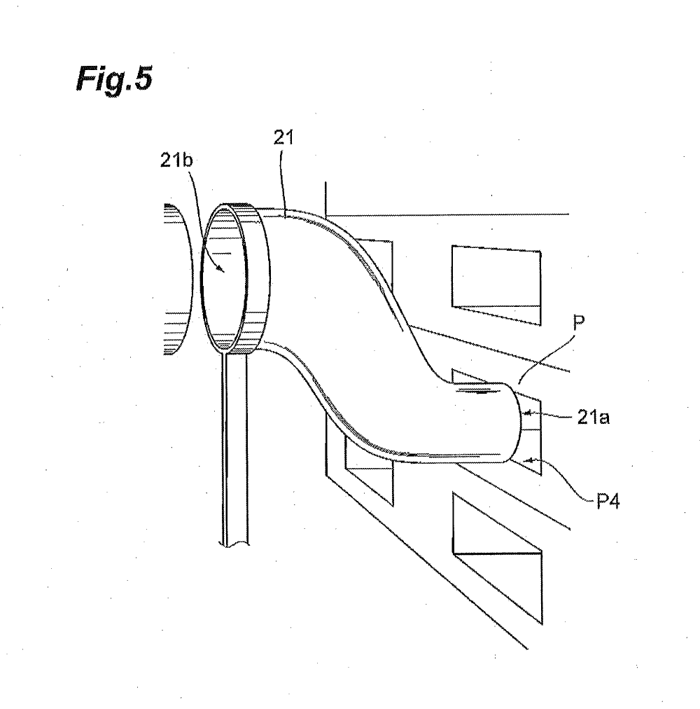

Next, the duct 21 will be described in detail with reference to FIG. 5. FIG. 5 is an enlarged diagram illustrating the duct 21 shown in FIG. 4. As shown in FIG. 5, the duct 21 includes an end 21a which is a hot-blast discharging port directed to the inside of the fork insertion hole P4. The positioning of the end 21a of the duct 21 with respect to the fork insertion hole P4 is adjusted with the height of the wagon 22 and the shape of the duct 21. Another end 21b of the duct 21 is positioned near the hot-blast discharging port of the hot blast generator 20. The other end 21b of the duct 21 may be connected to the hot-blast discharging port of the hot blast generator 20. It is preferable that the sectional shape of the other end 21b of the duct 21 correspond to that of the hot-blast discharging port of the hot blast generator 20 in order to guide the hot blast efficiently. Preferably, the length of the air (hot blast) flow path formed with the duct 21 is adjusted as short as possible in order to prevent temperature decrease within the layout restriction on the structure of the pallet drying device 1.

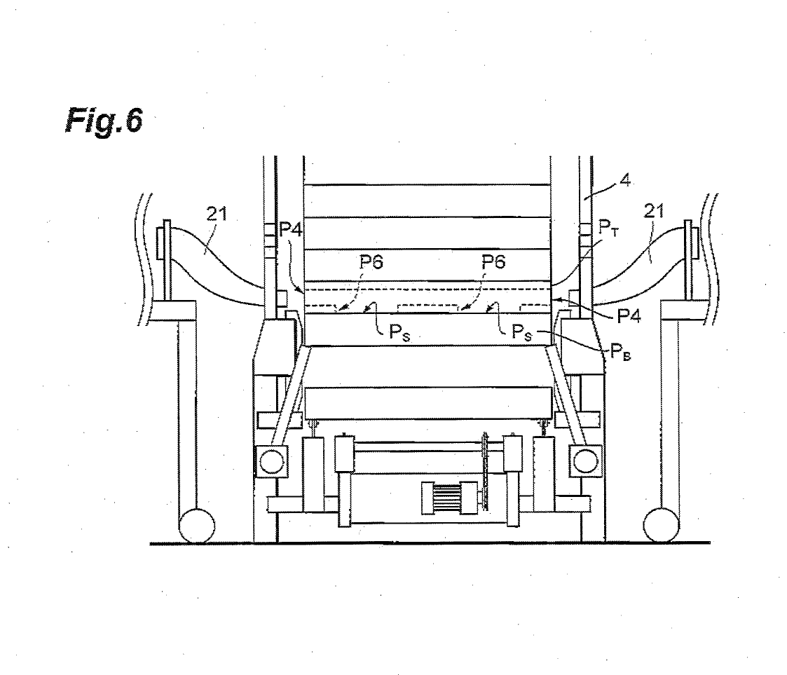

FIG. 6 is a side view illustrating the pallets P placed on the stacker 4. As shown in FIG. 6, a pallet PT to be dried is stacked with the other pallets by the stacker 4. The pallet PT is placed on a pallet

PB stacked under the pallet PT. Thus, the openings P6 of the pallet PT are blocked with an upper surface PS of the pallet PB mechanically. The openings P6 on the lower surface of the pallet PT to be dried are blocked as shown in the drawing, and the hot blast is generated to the fork insertion holes P4. Thus, the hot blast blown into the fork insertion holes P4 is not discharged from the openings P6. This configuration promotes drying the insides of the fork insertion holes P4. Furthermore, in the stacker 4, the pallet PB stacked under the pallet PT to be dried mechanically blocks the openings P6 of the pallet PT, thus the openings P6 on the lower surface of the pallet PT are reliably blocked without using a special component other than the devices generally used to handle the pallets P.

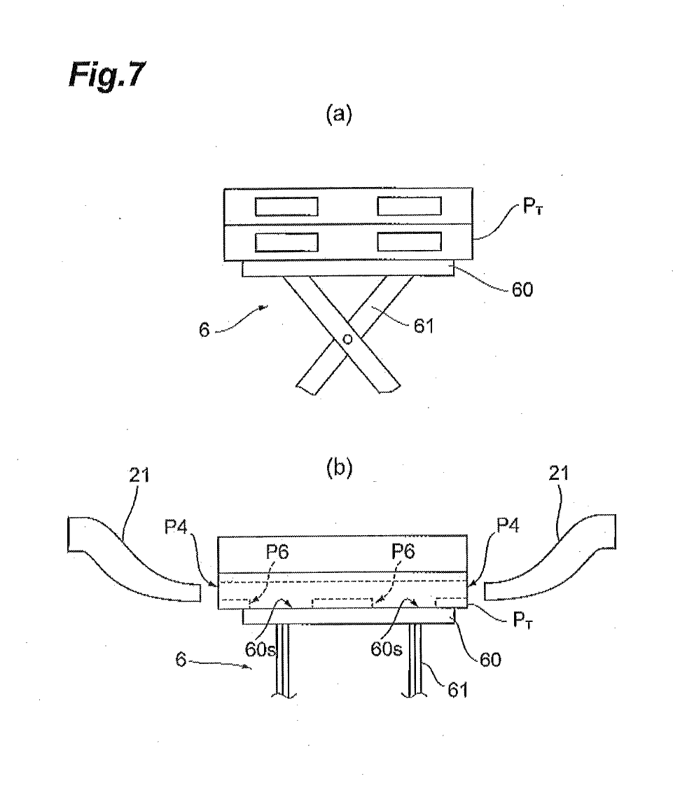

The pallet drying device 1 in the present embodiment may include a lifter as the pallet placing means instead of the stacker 4. FIG. 7(a) is a side view of the pallet PT placed on a lifter 6 seen along a perforating direction of the fork insertion holes P4. FIG. 7(b) is a side view of the pallet PT placed on the lifter 6 seen along a direction perpendicular to the perforating direction of the fork insertion holes P4.

The lifter 6 is a device that lifts a pallet placed thereon to any position. The stacker 6 in the present embodiment can be configured with a lifter well known to the skilled person and is not limited to the embodiment illustrated in the drawings. As shown in FIG. 7, the lifter 6 includes a table 60 including a placement surface 60S on which pallets are placed and a power source 61 configured to elevate the table 60.

As shown in FIG. 7, the pallet PT to be dried is placed on the placement surface 60S of the table 60. Thus, the openings P6 of the pallet. PT are blocked with the placement surface 60S of the table 60 mechanically. The openings P6 on the lower surface of the pallet PT to be dried are blocked as shown in the drawing, and the hot blast is generated to the fork insertion holes P4, thus the hot blast blown into the fork insertion holes P4 is not discharged from the openings P6. This configuration promotes drying the insides of the fork insertion holes P4. Furthermore, the table 60 of the lifter 6 on which the pallet PT to be dried is placed mechanically blocks the openings P6 of the pallet PT, thus the openings P6 on the lower surface of the pallet PT are reliably blocked without using a special component other than the devices generally used to handle the pallets P.

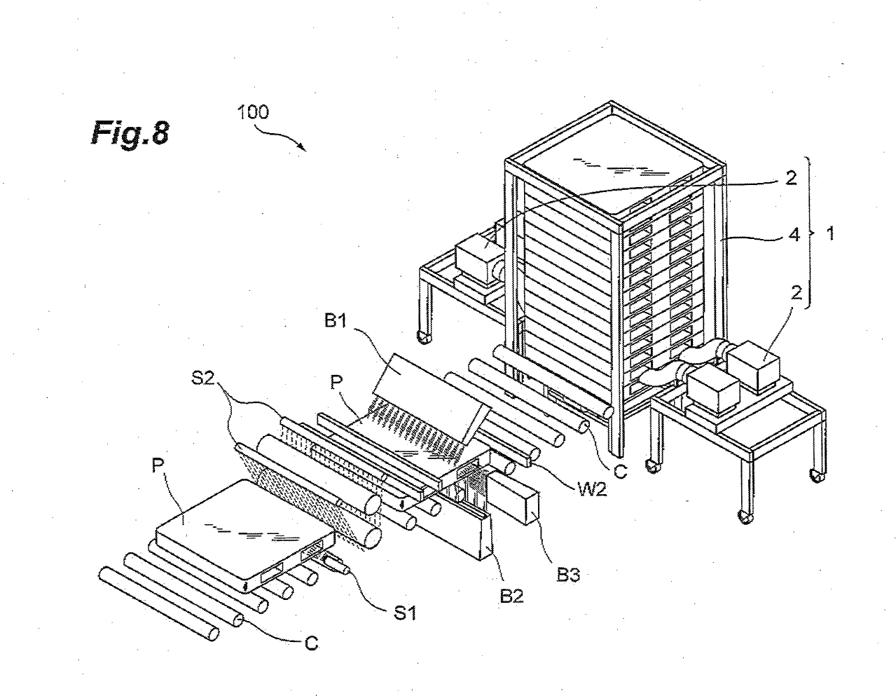

A pallet washing device including the pallet drying device 1 in the present embodiment will now be described. FIG. 8 is a perspective view of a pallet washing device 100. The pallet washing device 100 includes a side shower S1 and a mist shower S2 as washing units for washing a pallet with water, as shown in FIG. 8.

The side shower S1 is a device for washing the side surfaces and the insides of the fork insertion holes P4 of the pallet P with water, and sprays water from the side of the pallet P. The mist shower S2 is a device for washing the deck of the pallet P, and sprays water from above the pallet P and removes contamination on the pallet with a brush provided at the same position.

The pallet washing device 100 also includes a top surface dewatering wiper W1, high-pressure blowers B1, B2, and B3, and a back surface dewatering wiper W2 as means for removing water remaining on the pallet P. The pallet washing device 100 further includes a conveyor C which is a conveyance unit that conveys the pallet P from the washing unit to the water removing means and the pallet drying device 1.

The top surface dewatering wiper W1 and the back surface dewatering wiper W2 remove water remaining on the deck portion on the top surface side and the deck portion on the back surface side of the pallet P. The high-pressure blowers B1, B2, and B3 are devices that remove water remaining on the pallet P by blowing high-pressure air to the pallet; specifically, the blowers B1, B2, and B3 blow high-pressure air to the upper surface, the lower surface, and the side surface, respectively, of the pallet.

The high-pressure blower B3 is provided to remove water in the insides of the fork insertion holes P4. The high-pressure blower B3, however, cannot fully remove water in the insides of the fork insertion holes P4. In the pallet washing device 100 in the present embodiment, the pallet drying device 1 is provided at a stage subsequent to the washing unit, so that water left in the insides of the fork insertion holes P4 can be fully removed.

At a stage subsequent to the pallet drying device 1 in the pallet washing device 100, devices for carrying out other processes, for example, may be provided as necessary. For example, a line for checking for breakage of the pallets P may be provided at a stage subsequent to the pallet drying device 1.

In the pallet drying device 1 and the pallet drying method in the present embodiment, the pallet P to be dried is placed with the openings P6 on the lower surface blocked while the hot blast is generated to the fork insertion holes P4, thus the hot blast blown into the fork insertion holes P4 is not discharged from the openings P6. This configuration promotes drying the insides of the fork insertion holes P4. The hot blast generated to the pallet P is generated to the fork insertion holes P4 but not the entire pallet P, and therefore, a device generating the hot blast can be miniaturized. Consequently, the energy and cost needed to generate the hot blast can be reduced.

### REFERENCE SIGNS LIST

1 . . . pallet drying device, 2 . . . blowing means, 4 . . . stacker, 6 . . . lifter, 20 . . . hot blast generator, 21 . . . duct, 40 . . . pallet stacking unit, 41 . . . pallet receiving unit, 60 . . . table, 60S . . . placement surface, 61 . . . power source, 100 . . . pallet washing device, P, PT, PB . . . pallet, P3 . . . side surface, P4 . . . fork insertion hole, P6 . . . opening, Ps . . . upper surface.

1. A pallet drying method of promoting drying after washing of a pallet including a fork insertion hole into which a fork is inserted on a side surface and an opening communicating with the fork insertion hole on a lower surface, the pallet drying method comprising:
a pallet placing step of placing the pallet to be dried on a certain position to mechanically block the opening; and
a blowing step of blowing air into the inside of the fork insertion hole.

2. The pallet drying method according to claim 1, wherein
in the pallet placing step, a stacker that is a device for stacking a plurality of pallets stacks the pallets, and the opening of the pallet to be dried is blocked with an upper surface of one of the pallets stacked under the pallet to be dried.

3. The pallet drying method according to claim 1, wherein
in the pallet placing step, a lifter provided with a table including a placement surface on which the pallets are placed and a power source capable of lifting the table is used to place the pallet to be dried on the table, and the opening of the pallet to be dried is blocked with the placement surface of the table.

4. The pallet drying method according to claim 1, wherein
in the blowing step, air heated with a heat source is blown into the inside of the fork insertion hole.

5. A pallet drying device that promotes drying after washing of a pallet including a fork insertion hole into which a fork is inserted on a side surface and an opening communicating with the fork insertion hole on a lower surface, the pallet drying device comprising:
pallet placing means capable of placing the pallet to be dried so as to mechanically block the opening; and
blowing means for blowing air into the inside of the fork insertion hole.

6. The pallet drying device according to claim 5, wherein
the pallet placing means is provided with a stacker that is a device for stacking pallets, and the opening of the pallet to be dried is blocked with an upper surface of one of the pallets stacked under the pallet to be dried.

7. The pallet drying device according to claim 5, wherein
the pallet placing means includes a lifter provided with
a table including a placement surface on which the pallet is placed, and
a power source capable of lifting the table, and the opening of the pallet to be dried is blocked with the placement surface of the table.

8. The pallet drying device according claim 5, wherein
the blowing means includes
a heat source that heats air,
a blower that blows hot blast which is the air heated by the heat source, and
a duct that forms a flow path for the hot blast blown from the blower and includes a hot-blast discharging port directed to the inside of the fork insertion hole.

9. A pallet washing device for washing a pallet, comprising:
a washing unit that washes the pallet with water;
the pallet drying device according to claim 5 provided at a stage subsequent to the washing unit; and
a conveyance unit that conveys the pallet washed in the washing unit to the pallet placing means in the pallet drying device.
